(19) United States
(12) Patent Application Publication
(10) Pub. No.: US 2025/0148378 A1
(43) Pub. Date: May 8, 2025

(54) FACILITY MANAGEMENT DEVICE AND FACILITY MANAGEMENT METHOD

(71) Applicant: Toshiba Tec Kabushiki Kaisha, Tokyo (JP)

(72) Inventor: Akira YAMAZAKI, Izunokuni Shizuoka (JP)

(21) Appl. No.: 18/890,116

(22) Filed: Sep. 19, 2024

(30) Foreign Application Priority Data
Nov. 2, 2023 (JP) 2023-188398

(51) Int. Cl. G06Q 10/02; G06Q 20/10; G06Q 20/32

(52) U.S. Cl. CPC G06Q 10/02; G06Q 20/102; G06Q 20/322

(57) ABSTRACT

Embodiments enable a user of a facility to make settlement of fees associated with using the facility by using a mobile terminal. In one example, a management device includes a storage device, a communication interface to connect a store server, and a processor. The processor links, in a linkage table in the storage device, facility information to the user's mobile terminal information, fee receives data indicating fees associated with use of the facility by the user, provides the fee data to the mobile terminal linked to the facility information f the facility in the linkage table, receives a payment notification indicating that a payment of the fees has been executed at the mobile terminal, and executes processing for changing a use status of the facility after the payment notification is received.

### CROSS-REFERENCE TO RELATED APPLICATION

This application is based upon and claims the benefit of priority from Japanese Patent Application No. 2023-188398, filed Nov. 2, 2023, the entire contents of which are incorporated herein by reference.

### FIELD

Embodiments described herein relate generally to a facility management device and a facility management method.

### BACKGROUND

At a facility where food and drinks are served, such as a karaoke box, a darts bar, or a manga café, use fees may vary depending on the food and drinks also ordered. Therefore, it is common to make a final payment upon leaving the facility. Such a payment can normally be made at a payment terminal such as a POS (point of sales) terminal or a self-service POS terminal.

However, in recent times, a new settlement method called mobile settlement has become more widely used. In a mobile settlement process, a cashless payment of the fee or bill is made using settlement application software installed on a user's mobile terminal, such as a smartphone. Making mobile settlement available for payment at a facility can reduce congestion at otherwise crowded checkout or payment times. Accepting mobile settlements, while increasing user convenience, may also serve as a measure against transmission of infectious diseases.

For a user of a facility to pay using mobile settlement, a fee billing system constructed at the facility and a mobile terminal (generally owned by the customer of the facility) need to be linked together. However, in the current situation, the mechanism to link the fee billing system to the mobile terminal together is not well-established and therefore mobile settlement might not be available.

### BRIEF DESCRIPTION OF THE DRAWINGS

FIG. 1 depicts a schematic configuration of a facility management system according to an embodiment.

FIG. 2 is a sequence chart for explaining an outline of operations of a store system.

FIG. 3 depicts a data structure of a transaction record saved in a transaction file.

FIG. 4 depicts a data structure of an order record saved in an order file.

FIG. 5 is a block diagram of a mobile terminal.

FIG. 6 is a block diagram of an infrastructure server.

FIG. 7 is a schematic view showing the configuration of a linkage table.

FIG. 8 is a flowchart of operations of an infrastructure server when receiving an entry notification event or an exit notification event.

FIG. 9 is a flowchart of operations of a mobile terminal executing a store app.

FIG. 10 is a flowchart of slip reading processing executed by a mobile terminal and processing executed by an infrastructure server in conjunction with the slip reading processing.

FIG. 11 is a flowchart of merchandise order processing executed by a mobile terminal and processing executed by an infrastructure server in conjunction with the merchandise order processing.

FIG. 12 is a flowchart of payment processing executed by a mobile terminal and processing executed by the processor of an infrastructure server in conjunction with the payment processing.

FIG. 13 is a sequence chart for explaining an outline of operations of a facility management system including a mobile terminal.

FIG. 14 shows an example of a top screen displayed on a touch panel of a mobile terminal.

FIG. 15 shows an example of a reading screen displayed on a touch panel of a mobile terminal.

### DETAILED DESCRIPTION

An embodiment described herein relates to a facility management device, system, and method that enables a user using a facility to make settlement of fees associated with using the facility by using a mobile terminal owned by the user.

In general, according to one embodiment, a facility management device includes a storage device, a communication interface configured to connect a store server, and a processor. The processor is configured to link, in a linkage table in the storage device, facility information that specifies a facility being used by a user to terminal information that specifies a mobile terminal used by the user. The processor further receives fee data indicating fees associated with use of the facility by the user via the communication interface from the store server, provides the fee data to the mobile terminal linked to the facility information of the facility in the linkage table, receives a payment notification indicating that a payment of the fees has been executed at the mobile terminal, and executes processing for changing a use status of the facility after the payment notification is received.

An embodiment of a facility management device that enables a user using a facility to make settlement of fees involved in using the facility, with a mobile terminal owned by the user, will now be described with reference to the drawings.

In this embodiment, a karaoke box is employed as an example of the facility. The karaoke box is a facility where a user enjoys karaoke while also possibly eating and drinking. A karaoke box can also be called a karaoke room, a karaoke studio, a private karaoke room, or the like. The karaoke box is generally provided at a karaoke store with multiple boxes (rooms). The karaoke store tracks the current status of use of each karaoke box. Specifically, the karaoke store tracks an entry into the karaoke box (that is, a so-called check-in) and an exit from the karaoke box (that is, a so-called check-out). The karaoke store also provides food and drink menu items as ordered by the user. The karaoke store receives, from the user, a payment for the total sum of the use fee for the karaoke box and the prices of the ordered food and drink items at the time of check-out. The use fee may be a usage time based fee. This embodiment discloses a facility management device that enables a user of a karaoke box to make settlement of all fees (total sum) using a mobile terminal owned by the user in conjunction with a facility management system including this facility management device.

### Description of Facility Management System

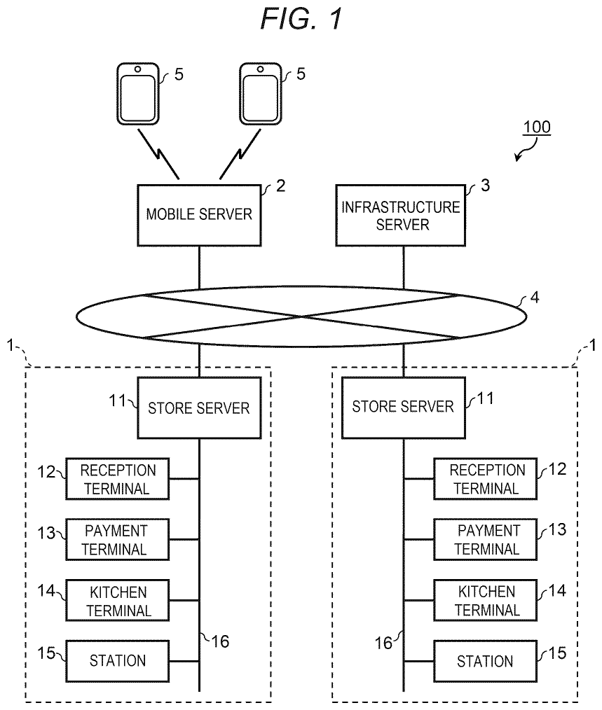

FIG. 1 is a schematic showing a schematic configuration of a facility management system 100. The facility management system 100 includes a plurality of store systems 1, a mobile server 2, and an infrastructure server 3. The infrastructure server 3 is an example of the facility management device.

The plurality of store systems 1 are common systems constructed at karaoke stores of a chain, respectively. The store system 1 includes a store server 11, a reception terminal 12, a payment terminal 13, a kitchen terminal 14, and a station 15. In the store system 1, the store server 11 is connected to the reception terminal 12, the payment terminal 13, the kitchen terminal 14, and the station 15 via a communication network 16 such as a LAN (local area network).

The reception terminal 12 and the payment terminal 13 are installed at a reception desk in the karaoke store. The reception desk is a place where the user stops by before entering the karaoke box or after exiting the karaoke box. The reception desk is also referred to as a front desk.

The reception terminal 12 accepts an entry to the karaoke box, that is, a so-called check-in. The check-in involves the tasks of inputting a room number, a member ID, whether there is a reservation or not, a karaoke fee plan selection, and a time of use with the fee plan or the like. The room number is unique identification information allocated on a per karaoke box basis in order to identify each of a plurality of karaoke boxes provided in the karaoke store.

The member ID is unique identification information allocated to a user who concluded a membership contract with the karaoke store, that is, a so-called store member or a program member. The user installs application software dedicated for the store, that is, a so-called store app, in a mobile terminal 5 (such as a smartphone or a tablet terminal) owned by the user himself or herself, and carries out member registration. As the user carries out member registration, the user becomes a member and a member ID unique to the user is allocated to the user. The member ID is displayed in the form of a machine-readable code such as a barcode or a two-dimensional code on the screen of the mobile terminal by activating the store app.

The payment terminal 13 accepts an exit from the karaoke box, that is, a so-called check-out. The payment terminal 13 then processes the settlement of the fees involved in using the karaoke box. The payment terminal 13 supports various payment methods such as cash, credit card, electronic money, and code settlement. The payment terminal 13 may be configured to support one of these payment methods. The payment terminal 13 can be rephrased as a settlement terminal, POS (point of sales) terminal or the like.

By the way, the reception terminal 12 and the payment terminal 13 may be staffed terminals operated by store staff or self-service terminals operated by the user by himself or herself. Alternatively, a single terminal device having both the functions of the reception terminal 12 and the functions of the payment terminal 13 may be employed.

The kitchen terminal 14 is a device for outputting information of a food and drink menu item ordered by the user of the karaoke box. The kitchen terminal 14 may be a type that displays information of the food and drink menu item on a display device and thus outputs the information or a type that prints the information of the food and drink menu item on a recording paper and thus outputs the information. Generally, the kitchen terminal 14 is installed in the kitchen of the karaoke store. Kitchen staff can determine the menu item ordered by the user of the karaoke box based on the information from the kitchen terminal 14, and then prepares and provides the food and drink menu item to the user accordingly.

The station 15 manages the information of the food and drink menu item(s) ordered by the user of the karaoke box. The station 15 stores the information of the food and drink menu item ordered by the user on a per karaoke box user basis. The station 15 calculates the price of the food and drink menu item(s) ordered by the user on a per user basis, based on the stored information.

The store server 11 controls the reception terminal 12, the payment terminal 13, the kitchen terminal 14, and the station 15 and supports the business operations of the karaoke store. For example, the store server 11 tracks the status of use of the karaoke box based on data provided by the reception terminal 12 and the payment terminal 13. Specifically, the store server 11 manages the karaoke box for which a check-in has been accepted at the reception terminal 12 as “in use”. Subsequently, when settlement for the user of the karaoke box is completed at the payment terminal 13, the store server 11 manages this karaoke box as “not in use”.

The store server 11 calculates the fees for using the karaoke box on a per user basis based on an established karaoke fee plan in effect at the check-in time at the reception terminal 12 and the prices of the food and drink menu item ordered at the corresponding station 15. The user pays the fees at the time of check-out. Therefore, the store system 1 can be referred to as a fee billing system of the karaoke store.

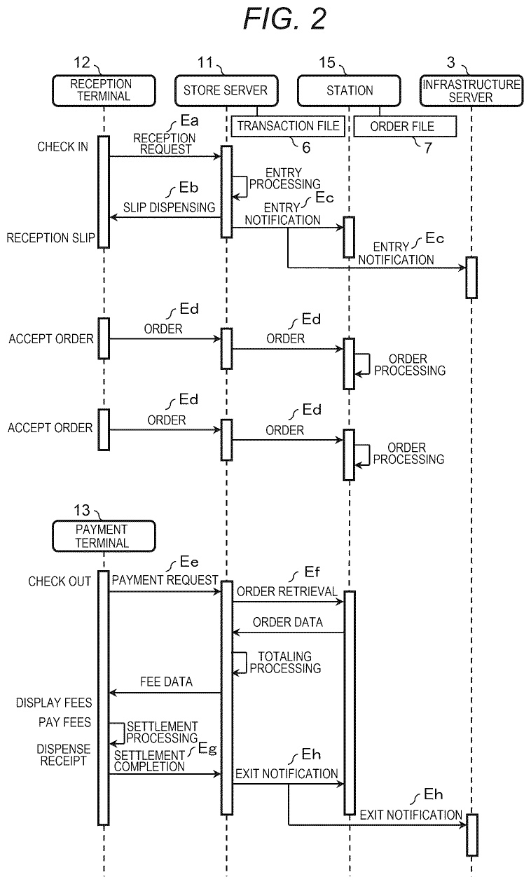

FIG. 2 is a sequence chart for explaining an outline of operations of the store system 1. The reception terminal 12 accepts a check-in. The operator of the reception terminal 12 inputs the room number of the karaoke box to be used by the user. The operator also inputs the karaoke fee plan selected by the user and the expected time of use for the user. If the user is a member (a member of loyalty program or the like), the operator inputs the member ID of the user. If the user has made a reservation beforehand, the operator inputs the reservation code. The operator of the reception terminal 12 may be store staff or the user himself or herself.

After accepting the check-in, the reception terminal 12 transmits a reception request event Ea to the store server 11. The reception request event Ea includes the room number, the member ID, the karaoke fee plan, and the time of use input at the time of check-in. Additional information provided at check-in may also be sent at this time to the store server 11. For example, if there was a reservation, the reception request event Ea may also include the reservation number or code.

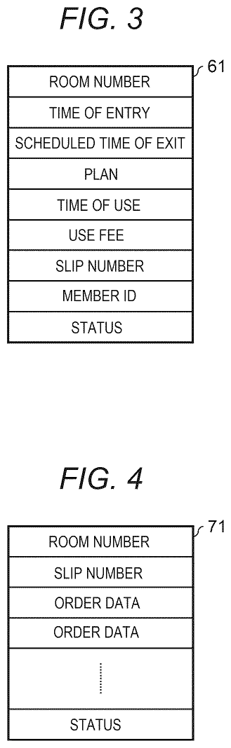

After receiving the reception request event Ea, the store server 11 executes entry processing. The entry processing generates a transaction record 61 with a data structure shown in FIG. 3 and then saves the transaction record 61 in a transaction file 6. The store server 11 uses a part of a memory area of a built-in or external memory device for the transaction file 6.

As shown in FIG. 3, the transaction record 61 includes a room number, a time of entry, a scheduled time of exit, a karaoke fee plan selection, a time of use (box usage time), a use fee, a slip number, a member ID, and a present status. The room number, the plan, the time of use, and the member ID are data included in the reception request event Ea.

The time of entry is the time when the check-in was carried out at the reception terminal 12. Alternatively, the time of entry may be the time when the store server 11 receives the reception request event Ea. The scheduled time of exit is the time when the selected time of use expires after the time of entry.

The use fee can be an amount derived from the selected karaoke fee plan and the time of use or the like. Normally, a basic fee per unit time (e.g., X yen/half-hour) is set as a fee plan. Therefore, the store server 11 multiplies the basic fee per unit time by the time of use and thus calculates the use fee.

The slip number is a unique number provided by the store server 11 every time the reception request event Ea is received. After finishing the check-in, the user is identified by the slip number until the user carries out a check-out.

The status represents the state of the karaoke box specified by the room number. The state of the karaoke box may be an in-use state and a not-in-use state. Since the transaction record 61 is generated in response to the reception of the reception request event Ea, that is, after the check-in, the status at the time of generating the transaction record represents the in-use state.

Referring back to FIG. 2, the description continues.

After finishing the entry processing, the store server 11 transmits a slip dispensing event Eb to the reception terminal 12. The slip dispensing event Eb includes the information of the transaction record 61. After receiving the slip dispensing event Eb, the reception terminal 12 dispenses a reception slip. On the reception slip, the room number, the time of entry, the scheduled time of exit, the karaoke fee plan, the time of use, the use fee, the slip number, and the like, are printed. Also, a machine-readable code such as a barcode or a two-dimensional code is printed on the reception slip. The machine-readable code represents the store code and the slip number in the form of a machine-readable code. The store code is unique identification information set on a per store basis in order to identify each karaoke store of the chain.

After finishing the entry processing, the store server 11 also transmits an entry notification event Ec to the station 15 and the infrastructure server 3. The entry notification event Ec is an event notifying that the user entered the karaoke box. The entry notification event Ec includes the room number included in the reception request event Ea and the slip number provided by the store server 11. If the reception request event Ea includes the member ID, the entry notification event Ec also includes the member ID. The entry notification event Ec also includes the store code. The operation of the infrastructure server 3 after receiving the entry notification event Ec will be described below.

After receiving the entry notification event Ec, the station 15 generates an order record 71 with a data structure shown in FIG. 4 and saves the order record 71 in an order file 7. The station 15 uses a part of a memory area of a built-in or external memory device, as the order file 7.

As shown in FIG. 4, the order record 71 includes the room number, the slip number, the order data, and the status. The room number and the slip number are data included in the entry notification event Ec. The order data is data of a food and drink menu item ordered by the user who entered the karaoke box specified by the room number. The status represents the state of the karaoke box specified by the room number, as in the transaction record 61. Since the order record 71 is generated in response to the reception of the entry notification event Ec, that is, after the check-in, the status at the time of generating the order record represents the in-use state.

Referring back to FIG. 2, the description continues.

The reception terminal 12 has an order acceptance function. The order acceptance function is the function of accepting ordering data for a food and drink menu item being ordered by the user. For example, the operator of the reception terminal 12 inputs the item code of a food and drink menu item being ordered by the user and the number of items (quantity) ordered or the like. The item code is unique identification information allocated on a per food and drink menu item basis. The reception terminal 12 transmits an order event Ed to the store server 11 every time a food or drink menu item is ordered. The order event Ed includes the room number of the karaoke box being used by the user, the item code of the food or drink menu item ordered by the user, and the number of items ordered or the like.

After receiving the order event Ed, the store server 11 transfers the order event Ed to the station 15. The station 15 executes order processing every time the station 15 receives the order event Ed. The order processing is to generate order data made up of the item code and the number of items ordered included in the order event Ed. The order data includes the item code, the item name and the price of the food and drink menu item specified by the item code, the number of items ordered, and the amount calculated by multiplying the price by the number of items ordered. The station 15 adds the order data to the order record 71 in which the room number included in the order event Ed is set.

The payment terminal 13 accepts a check-out by the user who used the karaoke box. The operator of the payment terminal 13 inputs the slip number of the reception slip dispensed at the time of reception to the user exiting the karaoke box. The operator causes a scanner to read the machine-readable code printed on the reception slip and thus inputs the slip number. The operator may be store staff or the user himself or herself.

After accepting the check-out, the payment terminal 13 transmits a payment request event Ee to the store server 11. The payment request event Ee includes the slip number. After receiving the payment request event Ee, the store server 11 transmits an order retrieval event Ef to the station 15. The order retrieval event Ef includes the slip number acquired from the payment request event Ee.

After receiving the order retrieval event Ef, the station 15 acquires the order record 71 including the slip number acquired from the order retrieval event Ef. The station 15 sends back the order data included in the order record 71 to the store server 11.

The store server 11 executes totaling processing. This processing is the adding up the use fee in the transaction record 61 including the slip number acquired from the payment request event Ee and the price of the food and drink menu item calculated based on the order data acquired from the station 15. If the time of exit when the check-out is carried out is later than the scheduled time of exit, the store server 11 adds an extension fee to the use fee. The store server 11 then adds up the use fee with the extension fee added and the price of the food and drink menu item.

After finishing the totaling processing, the store server 11 transmits fee data to the payment terminal 13. The fee data is data of the amount acquired by adding up the use fee of the karaoke box and the price of the food and drink menu item, that is, the fees involved in using the karaoke box. The fee data includes details of the fees, for example, the use fee of the karaoke box, the item name and the price of the food and drink menu item, the number of items ordered, and the like.

After receiving the fee data, the payment terminal 13 displays the fees on the display device and accepts the payment After accepting the payment, the payment terminal of the fees. 13 executes settlement processing. If, for example, the fees are paid by cash, the settlement processing is the processing of subtracting the fees from the amount paid and thus calculating the difference as change. If, for example, the fees are paid by credit card, the settlement processing is the processing of requesting the settlement server of the credit card to authenticate the credit card and dispensing a credit slip if the credit card is authenticated. If, for example, the fees are paid by electronic money, the settlement processing is the processing of subtracting the fees from the balance of the electronic money.

After finishing the settlement processing, the payment terminal 13 dispenses a receipt. The receipt may be dispensed as a receipt printed a paper medium or may be dispensed as an electronic receipt that is viewable on the smartphone of the user. The payment terminal 13 also transmits a settlement completion event Eg to the store server 11. The settlement completion event Eg includes the slip number provided at the time of check-out. After receiving the settlement completion event Eg, the store server 11 updates the status in the transaction record 61 in which the slip number acquired from the settlement completion event Eg is set, from the in-use state to the not-in-use state. The store server 11 also transmits an exit notification event Eh to the station 15 and the infrastructure server 3. The exit notification event Eh includes the slip number acquired from the settlement completion event Eg and the room number in the transaction record 61 in which the slip number is set. The exit notification event Eh also includes the store code. After receiving the exit notification event Eh, the station 15 updates the status in the order record 71 including the room number and the slip number acquired from the exit notification event Eh from the in-use state to the not-in-use state. The operation of the infrastructure server 3 after receiving the exit notification event Eh will be described below.

Referring back to FIG. 1, the description continues.

In the facility management system 100, the store server 11 of each store system 1, the mobile server 2, and the infrastructure server 3 are connected via an inter-server network 4. The inter-server network 4 is typically the internet or an intranet.

The mobile server 2 provides a bidirectional data communication service for the mobile terminal 5 owned by the user of the karaoke box. The mobile server 2 provides the data communication service, for example, using a short-range wireless communication network such as Wi-Fi (trademark registered), or a mobile communication network or the like.

The infrastructure server 3 links together the store system 1 functioning as the fee billing system and the mobile terminal 5 owned by the user of the karaoke box in the karaoke store where the corresponding store system 1 is constructed. The infrastructure server 3 provides a first service to enable the user of the karaoke box to order a food and drink menu item by using the mobile terminal 5. The infrastructure server 3 also provides a second service to enable the user of the karaoke box to pay the fees involved in using the karaoke box by mobile settlement with the mobile terminal 5. The infrastructure server 3 may provide the services in an on-premise environment or may provide the services in a cloud computing environment.

### Description of Configuration of Mobile Terminal

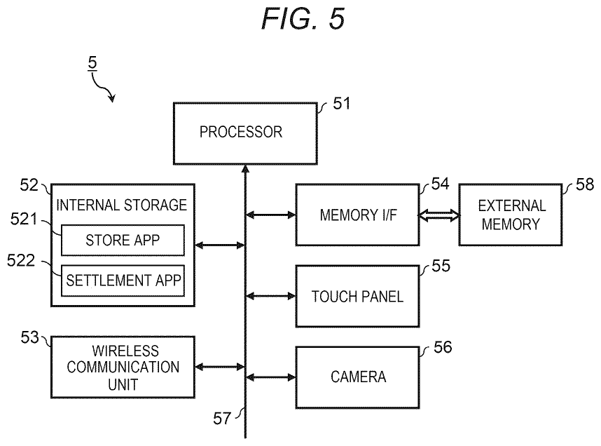

FIG. 5 is a block diagram showing a configuration of the mobile terminal 5. The mobile terminal 5 has a processor 51, an internal storage 52, a wireless communication unit 53, a memory interface 54, a touch panel 55, a camera 56, and a system transmission path 57 or the like. The system transmission path 57 includes an address bus, a data bus, a control signal line, and the like. The system transmission path 57 connects the processor 51 to each of the other elements directly or via a signal input-output circuit and transmits a data signal sent and received between these elements.

In the mobile terminal 5, the processor 51, the internal storage 52, and the wireless communication unit 53 are connected together via the system transmission path 57. In the mobile terminal 5, the memory interface 54, the touch panel 55, the camera 56, and the like are connected to this computer by the system transmission path 57 via a signal input-output circuit or the like. The memory interface 54 is an interface to transmit and receive a data signal to and from a removably attached external memory 58. The external memory 58 is typically an SD memory card, a mini SD card, a micro SD card, or the like. The touch panel 55 functions as a display device and an input device of the mobile terminal 5. The camera 56 functions as an image pickup device of the mobile terminal 5. The interface and devices or the like connected to the system transmission path 57 are not limited to the above examples. Other interfaces and devices or the like may be connected.

The processor 51 controls each component in order to implement various functions of the mobile terminal 5 based on instructions of an operating system and/or an application program. The processor 51 is, for example, a CPU (central processing unit).

The internal storage 52 is a memory inside the casing of the mobile terminal 5. The internal storage 52 stores an operating system or an application program. The internal storage 52 may store necessary data for the processor 51 to execute processing to control each element.

The wireless communication unit 53 is configured to carry out wireless data communication with the mobile server 2, for example, using a short-range wireless communication network such as Wi-Fi, or a mobile communication network or the like.

For example, a smartphone, a tablet terminal or the like carried by the user can be the mobile terminal 5. The mobile terminal 5 stores a store app 521 in the internal storage. The mobile terminal 5 also stores a settlement app 522 in the internal storage. The settlement app 522 is application software to process mobile settlement. Mobile settlement refers to cashless settlement using the mobile terminal 5. Registering information of a credit card, electronic money or the like along with the settlement app 522 in the mobile terminal 5 enables the mobile terminal 5 to carry out mobile settlement.

The location of installation of the store app 521 and the settlement app 522 is not limited to the internal storage 52. The store app 521 and the settlement app 522 may be installed in the external memory 58. Alternatively, one app, for example, the store app 521, may be installed in the internal storage, and the other app, that is, the settlement app 522, may be installed in the external memory 58.

### Description of Configuration of Infrastructure Server

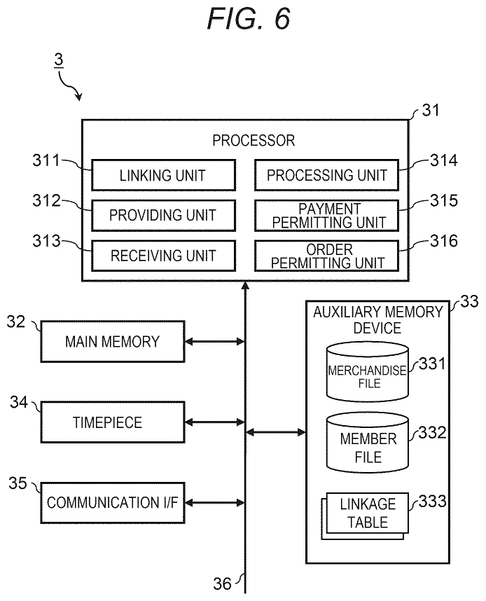

FIG. 6 is a block diagram showing a configuration of the infrastructure server 3. The infrastructure server 3 has a processor 31, a main memory 32, an auxiliary memory device 33, a timepiece 34, a communication interface 35, and a system transmission path 36 or the like. The system transmission path 36 includes an address bus, a data bus, a control signal line or the like. The system transmission path 36 connects the processor 31 to each of the other elements and transmits a data signal sent and received between these elements. In the infrastructure server 3, the processor 31, the main memory 32, the auxiliary memory device 33, the timepiece 34, and the communication interface 35 are connected together via the system transmission path 36.

The processor 31 controls each element in order to implement various functions of the infrastructure server 3. Such processing and control may be based on an operating system and/or an application program. The processor 31 is, for example, a CPU. Preferably, the processor 31 may be a multi-core processor that includes a plurality of processor cores and can execute a plurality of processes in parallel.

The main memory 32 includes a non-volatile memory area and a volatile memory area. The main memory 32 stores an operating system or an application program in the non-volatile memory area. The main memory 32 may store necessary data for the processor 31 to execute processing to control each element, in the non-volatile or volatile memory area. The main memory 32 uses the volatile memory area as a work area where data is rewritten by the processor 31 according to need. The non-volatile memory area is, for example, a ROM (read-only memory). The volatile memory area is, for example, a RAM (random-access memory).

For example, an EEPROM (electrically erasable programmable read-only memory), an HDD (hard disk drive), an SSD (solid-state drive), or the like can be the auxiliary memory device 33. The auxiliary memory device 33 stores data used by the processor 31 to execute various processing and data generated by the processing by the processor 31. The auxiliary memory device 33 may store the application program.

The timepiece 34 (clock) tracks date and time. The processor 31 processes the date and time tracked by the timepiece 34 as the current date and time.

The communication interface 35 is an interface for data communication with the other servers connected to the inter-server network 4, that is, the store server 11 and the mobile server 2.

In the infrastructure server 3 of such a configuration, a part of the memory area in the auxiliary memory device 33 is defined as a merchandise file 331, a member file 332, and a store-specific linkage table 333 in order to implement the foregoing first and second services.

The merchandise file 331 stores data about various food and drink menu items provided to the user at the karaoke store. Specifically, the merchandise file 331 stores data of the item name and the price of the like in correlation with the merchandise code of each menu item.

The member file 332 stores data about the user who is a member of the karaoke store. Specifically, the member file 332 stores data of the name, the email address, the membership validity period or the like in correlation with the member ID of the user.

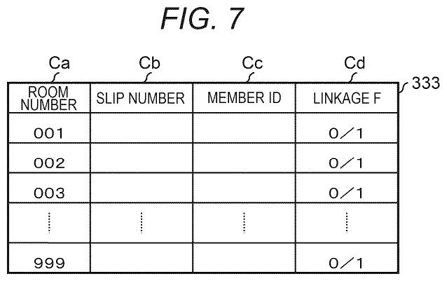

The linkage table 333 is prepared on a per karaoke store basis of the chain. The linkage tables 333 are of the same configuration and are identified by the respective store codes. The linkage table 333 is made up of a column Ca for room number, a column Cb for slip number, a column Cc for member ID, and a column Cd for linkage flag F, as shown in FIG. 7. In the column Ca, the room number of each karaoke box provided in the karaoke store specified by the store code is listed. In the column Cb and the column Cc, the slip number of the reception slip dispensed to the user entering the karaoke box and the member ID of the user are listed once the user enters the karaoke box. If the user is not a member, no member ID is listed in the column Cc. In the column Cd, a linkage flag F is provided. The linkage flag F is 1-bit data to identify whether the karaoke box specified by the room number and the mobile terminal 5 of the user entering this karaoke box are linked with each other or not. In this embodiment, the linkage flag F value indicating that the karaoke box and the mobile terminal 5 are not linked with each other is “0”, whereas the linkage flag F value indicating that the karaoke box and the mobile terminal 5 are linked with each other is “1”.

Also, in the infrastructure server 3, the processor 31 is configured to have functions of a linking unit 311, a providing unit 312, a receiving unit 313, a processing unit 314, a payment permitting unit 315, and an order permitting unit 316 in order to implement the foregoing first and second services. These functions can be implemented by a control program installed in the main memory 32 or the auxiliary memory device 33 of the infrastructure server 3. The method for installing the control program in the main memory 32 or the auxiliary memory device 33 is not particularly limited. A control program distributed via the inter-server network 4 can be received and installed in the main memory 32 or the auxiliary memory device 33. Alternatively, the control program can be recorded in a removable recording medium and installed in the main memory 32 or the auxiliary memory device 33. The recording medium may be provided in any format that can store a program and be read by a device, such as a CD-ROM or a memory card.

The linking unit 311 provides the function of linking together facility information that corresponds to the facility being used by the user and terminal information that identifies the mobile terminal 5 being used by a particular user. In the store app 521 installed in the mobile terminal 5, the member ID can be set as information that identifies the owner of the member terminal 5. That is, the member ID can be any terminal information that identifies the mobile terminal 5 being used by the user. The karaoke box, which is the present example of a facility used by the user, is identified by a room number in this case. That is, a room number or the like can be any facility information that particularly specifies the facility being used by the particular user. Using the linkage table 333, the linking unit 311 links together the room number (as the facility information that specifies the facility used by the user) and the member ID (as the terminal information that specifies the mobile terminal 5 being used by the user of the room (the karaoke box).

The providing unit 312 provides the function of information about the fees involved in using the providing facility to the mobile terminal 5 specified by the terminal information linked to the facility information of a facility. That is, the providing unit 312 provides information about the fees involved in using the facility, that is, the fees for using the karaoke box, to the mobile terminal 5 specified by the member ID linked with the room number of a karaoke box. Specifically, the providing unit 312 transmits the fee data to the mobile terminal 5 by wireless communication via the mobile server 2.

The receiving unit 313 provides the function of receiving a notification that the settlement of the fees is executed at the mobile terminal 5. As described above, the mobile terminal 5 can carry out mobile settlement by using the settlement app 522. The receiving unit 313 receives a notification that the settlement of the fees is executed by mobile settlement at the mobile terminal 5. Specifically, the receiving unit 313 receives, via the mobile server 2, a settlement completion event Eg when the settlement is executed by mobile settlement at the mobile terminal 5, and thus receives the notification that the settlement is executed.

The processing unit 314 provides the function of executing processing for ending the use of the facility. That is, the processing unit 314 executes processing for ending the use of the karaoke box specified by the room number linked with the member ID of the mobile terminal 5 on which the mobile settlement was executed. Specifically, the processing unit 314 changes the linkage flag F stored in the linkage table 333 in correlation with the room number of this karaoke box from “1” to “0”. The processing unit 314 also transmits the settlement completion event Eg to the store server 11 via the inter-server network 4.

The payment permitting unit 315 provides the function of checking whether the terminal information of the mobile terminal 5 is linked with the facility information or not, in response to a payment request from this mobile terminal 5, and permitting the payment only if the terminal information is linked with the facility information. That is, as the payment permitting unit 315 receives a payment request event Ee from a mobile terminal 5, the payment permitting unit 315 searches the linkage table 333 and checks whether the member ID of this mobile terminal 5 is linked with a room number or not. If the member ID of this mobile terminal 5 is linked with a room number, the payment permitting unit 315 permits the mobile terminal 5 to carry out payment. Specifically, the payment permitting unit 315 transmits the fee data to the mobile terminal 5 by wireless communication via the mobile server 2.

The order permitting unit 316 provides the function of checking whether the terminal information of a mobile terminal 5 is linked with the facility information or not, in response to a merchandise order request from this mobile terminal 5, and accepting an order of a merchandise item only if the terminal information is linked with the facility information. That is, as the order permitting unit 316 receives an order event Ed from a mobile terminal 5, the order permitting unit 316 searches the linkage table 333 and checks whether the member ID of this mobile terminal 5 is linked with a room number or not. If the member ID of this mobile terminal 5 is linked with a room number, the order permitting unit 316 accepts the order of the merchandise item from the mobile terminal 5. Specifically, the order permitting unit 316 transmits the order event Ed to the store server 11 via the inter-server network 4. In this context, merchandise may include food and/or drink.

### Description of Operations of Mobile Terminal and Infrastructure Server

First, the operation of the infrastructure server 3 in the case where the infrastructure server 3 receives an entry notification event Ec or an exit notification event Eh from the store server 11 of the store system 1 will be below.

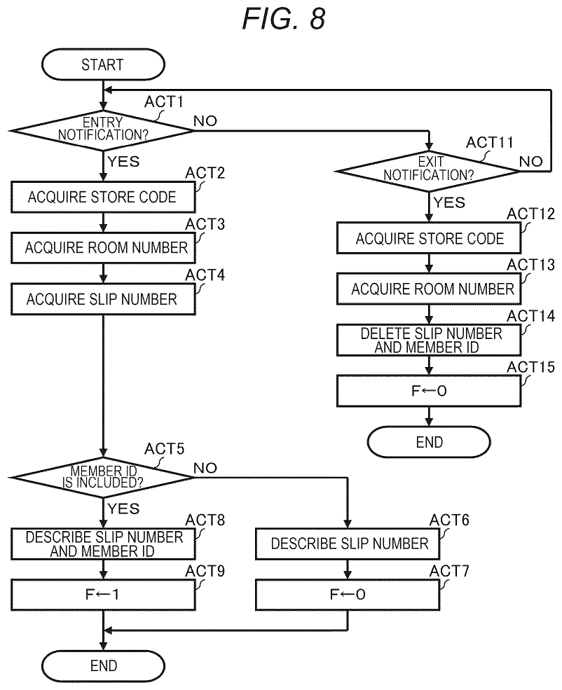

FIG. 8 is a flowchart showing operation procedures in when the processor 31 of the infrastructure server 3 receives the entry notification event Ec or the exit notification event Eh. That is, when the processor 31 receives the entry notification event Ec in ACT 1, the processor 31 proceeds to ACT 2. In ACT 2, the processor 31 acquires the store code from the entry notification event Ec. In ACT 3, the processor 31 acquires the room number from the entry notification event Ec. In ACT 4, the processor 31 acquires the slip number from the entry notification event Ec.

After that, in ACT 5, the processor 31 checks whether a member ID is included in the entry notification event Ec or not. If a member ID is not included in the entry notification event Ec, the processor 31 proceeds to ACT 6. In ACT 6, the processor 31 searches the linkage table 333 identified by the store code acquired from the entry notification event Ec and describes the slip number acquired from the entry notification event Ec in the column Cb corresponding to the room number acquired from the entry notification event Ec. In ACT 7, the processor 31 sets “0” as the linkage flag F in the column Cd corresponding to this room number.

On the other hand, if a member ID is included in the entry notification event Ec, the processor 31 proceeds to ACT 8. In ACT 8, the processor 31 searches the linkage table 333 identified by the store code acquired from the entry notification event Ec and describes the slip number and the member ID acquired from the entry notification event Ec in the columns Cb and Cc corresponding to the room number acquired from the entry notification event Ec. In ACT 9, the processor 31 sets “1” as the linkage flag F in the column Cd corresponding to this room number. Thus, by the processing of ACTS 8 and 9, the processor 31 implements the functions of the linking unit 311.

If the processor 31 receives the exit notification event Eh in ACT 11, the processor 31 proceeds to ACT 12. In ACT 12, the processor 31 acquires the store code from the exit notification event Eh. In ACT 13, the processor 31 acquires the room number from the exit notification event Eh.

Next, in ACT 14, the processor 31 searches the linkage table 333 identified by the store code acquired from the exit notification event Eh and deletes the slip number and the member ID listed in the columns Cb and Cc corresponding to the room number acquired from the exit notification event Eh. In ACT 15, the processor 31 sets “0” as the linkage flag F in the column Cd corresponding to this room number. Thus, by the processing of ACTS 14 and 15, the processor 31 implements the functions of a linkage cancelling unit that cancels the linkage between the facility information and the terminal information linked together by the linking unit 311.

The operation of the mobile terminal 5 and the operation of the infrastructure server 3 correlated with the operation of the mobile terminal 5 will now be described.

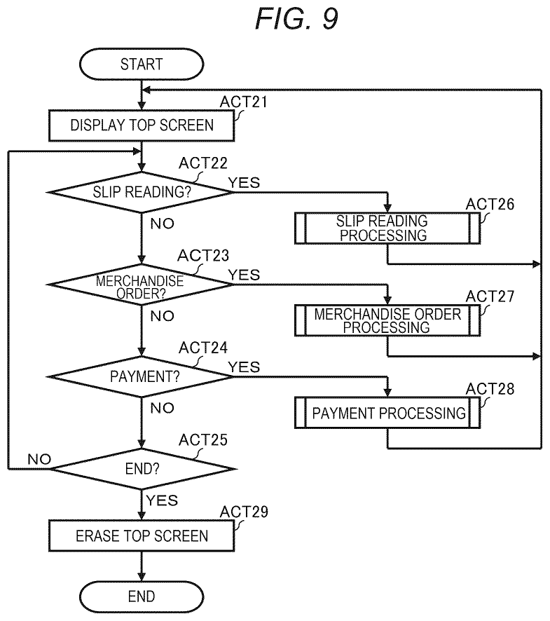

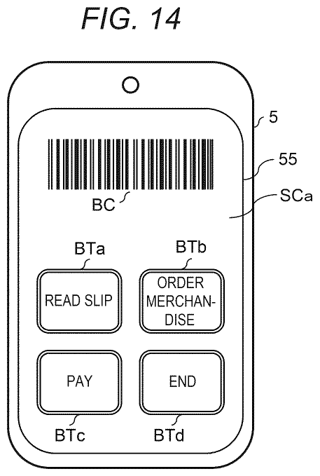

FIG. 9 is a flowchart showing procedures of information processing executed by the processor 51 of the mobile terminal 5 based on the store app 521. As the store app 521 is activated, the processor 51 starts information processing according to the procedures shown in the flowchart of FIG. 9. First, in ACT 21, the processor 51 displays a top screen SCa (see FIG. 14) as the screen on the touch panel 55.

FIG. 14 shows an example of the display of the top screen SCa. As shown in FIG. 14, a machine-readable code representing the member ID, for example, a barcode BC, is displayed on the top screen SCa. Also, various soft key buttons such as a slip reading button BTa, a merchandise order button BTb, a payment button BTc, and an end button BTd are displayed. The slip reading button BTa is an operating element that gives an instruction to read the slip number printed on the reception slip. The merchandise order button BTb is an operating element that gives an instruction to order a food and drink menu item. The payment button BTc is an operating element that gives an instruction to carry out settlement by mobile settlement. Therefore, in a mobile terminal 5 in which the settlement app 522 is not installed, the payment button BTc will not be displayed on the top screen SCa. Alternatively, the payment button BTc may be grayed out and use-disabled. The end button BTd is an operating element that gives an instruction to end (close) the store app 521.

Referring back to FIG. 9, the description continues.

The processor 51 of the mobile terminal 5 displaying the top screen SCa waits until the slip reading button BTa is entered in ACT 22, until the merchandise order button BTb is entered in ACT 23, until the payment button BTc is entered in ACT 24, or until the end button BTd is entered in ACT 25.

If the slip reading button BTa is entered in the waiting state of ACTS 22 to 25, the processor 51 proceeds to ACT 26. In ACT 26, the processor 51 executes slip reading processing. After the slip reading processing ends, the processor 51 returns to ACT 21. That is, the processor 51 displays the top screen SCa as the screen on the touch panel 55.

If the merchandise order button BTb is entered in the waiting state of ACTS 22 to 25, the processor 51 proceeds to ACT 27. In ACT 27, the processor 51 executes merchandise order processing. After the merchandise order processing ends, the processor 51 returns to ACT 21. That is, the processor 51 displays the top screen SCa as the screen on the touch panel 55.

If the payment button BTc is entered in the waiting state of ACTS 22 to 25, the processor 51 proceeds to ACT 28. In ACT 28, the processor 51 executes payment processing. After the payment processing ends, the processor 51 returns to ACT 21. That is, the processor 51 displays the top screen SCa as the screen on the touch panel 55.

If the end button BTd is entered in the waiting state of ACTS 22 to 25, the processor 51 proceeds to ACT 29. In ACT 29, the processor 51 erases the top screen SCa. The processor 51 thus ends the information processing based on the store app 521.

### Slip Reading Processing

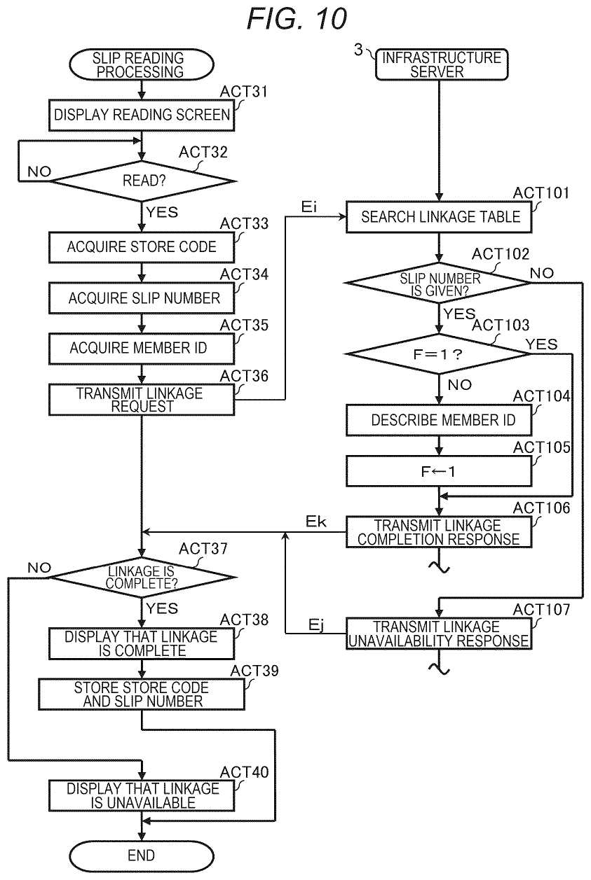

FIG. 10 is a flowchart showing procedures of the slip reading processing executed by the processor 51 of the mobile terminal 5 and procedures of the information processing executed by the processor 31 of the infrastructure server 3 in conjunction with the slip reading processing.

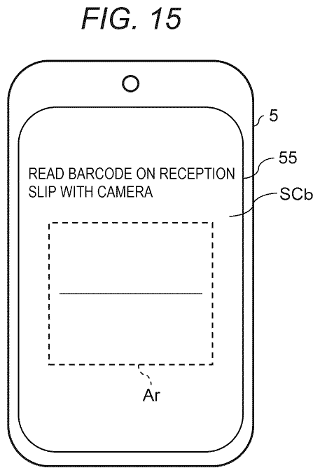

As the processor 51 of the mobile terminal 5 starts the slip reading processing, the processor 51 in ACT 31 displays a reading screen SCb (see FIG. 15) as the screen on the touch panel 55.

FIG. 15 shows an example of the display of the reading screen SCb. As illustrated, a reading area Ar for the camera 56 to read a machine-readable code (barcode or two-dimensional code) printed on the reception slip is displayed on the reading screen SCb. If the lens of the camera 56 is held over the reception slip in such a way that the machine-readable code falls within this reading area Ar, the machine-readable code is read.

The processor 51 of the mobile terminal 5 displaying the reading screen SCb proceeds to ACT 32. In ACT 32, the processor 51 waits until the machine-readable code is read. If the machine-readable code is read by the camera 56, the processor 51 proceeds to ACT 33. In ACT 33, the processor 51 acquires the store code from the machine-readable code. In ACT 34, the processor 51 acquires the slip number from the machine-readable code. In ACT 35, the processor 51 acquires the member ID registered in the store app 521.

In ACT 36, the processor 51 controls the wireless communication unit 53 to transmit a linkage request event Ei to the infrastructure server 3. This control causes the linkage request event Ei to be wirelessly transmitted from the mobile terminal 5. The linkage request event Ei is received by the mobile server 2 and transmitted to the infrastructure server 3 via the inter-server network 4. The linkage request event Ei includes the store code acquired in ACT 33, the slip number acquired in ACT 34, and the member ID acquired in ACT 35.

After receiving the linkage request event Ei, the processor 31 of the infrastructure server 3 in ACT 101 searches the linkage table 333 specified by the store code included in the linkage request event Ei. In ACT 102, the processor 31 checks whether the slip number included in the linkage request event Ei is listed in the column Cb in the linkage table 333 or not. If this slip number is not listed in the column Cb in the linkage table 333, the processor 31 proceeds to ACT 107. In ACT 107, the processor 31 transmits a linkage unavailability response event Ej to the mobile terminal 5 that sent the linkage request event Ei.

On the other hand, if this slip number is listed in the column Cb in the linkage table 333, the processor 31 proceeds to ACT 103. In ACT 103, the processor 31 checks the linkage flag F in the linkage table 333. If the linkage flag F is “1”, the member ID is linked with this slip number by the processing associated with the entry notification event Ec received from the store server 11. The processor 31 proceeds to ACT 106. In ACT 106, the processor 31 transmits a linkage completion response event Ek to the mobile terminal 5 that sent the linkage request event Ei.

If the linkage flag F is “0”, the processor 31 proceeds to ACT 104. In ACT 104, the processor 31 describes the member ID included in the linkage request event Ei, in the column Cc in the row where this slip number is listed, in the linkage table 333. The processor 31 also sets “1” as the linkage flag F in the same row. After that, the processor 31 proceeds to ACT 106. In ACT 106, the processor 31 transmits the linkage completion response event Ek to the mobile terminal 5 that sent the linkage request event Ei. After transmitting the linkage request event Ei, the processor 51 of the mobile terminal 5 waits for an event from the infrastructure server 3 in ACT 37. If the processor 51 receives the linkage completion response event Ek from the infrastructure server 3 via the wireless communication unit 53, the processor 51 proceeds ACT 38. In ACT 38, the processor 51 displays an image showing that the linkage between the room number and the member ID is complete, at a part of the top screen SCa. In ACT 39, the processor 51 stores the store code and the slip number acquired from the machine-readable code on the reception slip.

On the other hand, if the processor 51 receives the linkage unavailability response event Ej from the infrastructure server 3 via the wireless communication unit 53, the processor 51 proceeds to ACT 40. In ACT 40, the processor 51 displays an image showing that the linkage between the room number and the member ID is unavailable, at a part of the top screen SCa.

Thus, the user of the mobile terminal 5 can easily check whether the user's own member ID is linked with the room number of the karaoke box which the user himself or herself entered, based on the image in the top screen SCa.

### Merchandise Order Processing

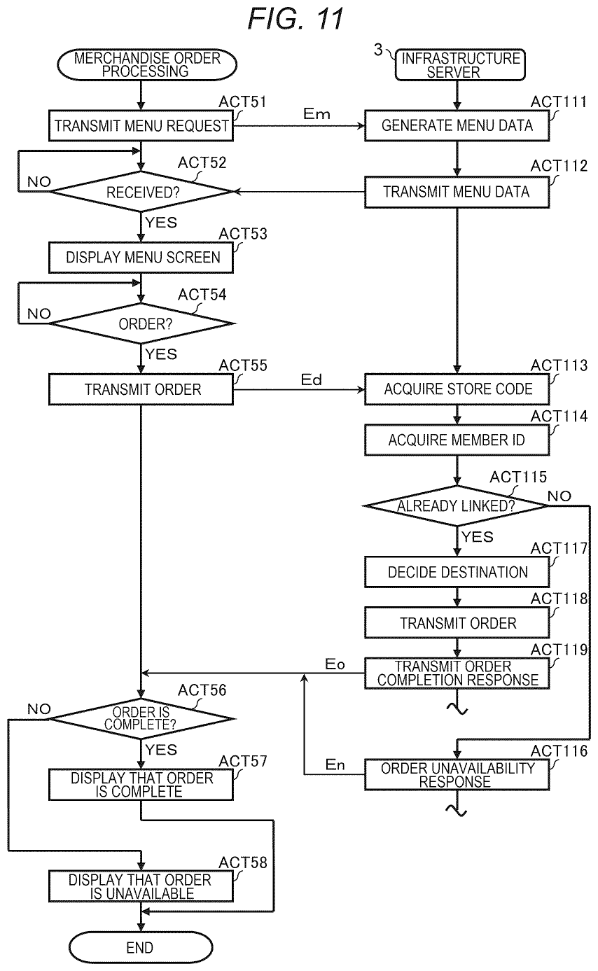

FIG. 11 is a flowchart showing procedures of the merchandise order processing executed by the processor 51 of the mobile terminal 5 and procedures of the information processing executed by the processor 31 of the infrastructure server 3 in conjunction with the merchandise order processing.

As the processor 51 of the mobile terminal 5 starts the merchandise order processing, the processor 51 in ACT 51 controls the wireless communication unit 53 to transmit a menu request event Em to the infrastructure server 3. This control causes the menu request event Em to be wirelessly transmitted from the mobile terminal 5. The menu request event Em is received by the mobile server 2 and transmitted to the infrastructure server 3 via the inter-server network 4.

After receiving the menu request event Em, the processor 31 of the infrastructure server 3 in ACT 111 generates menu data based on data about food and drink menu items stored in the merchandise file 331. The menu data is data to display a menu screen on the touch panel 55 of the mobile terminal 5. On the menu screen, a list of item names and prices of food and drink menu items available for order at the karaoke store is displayed. In ACT 112, the processor 31 transmits the menu data to the mobile terminal 5 that sent the menu request event Em.

After transmitting the menu request event Em, the processor 51 of the mobile terminal 5 waits for the menu data in ACT 52. If the processor 51 receives the menu data via the wireless communication unit 53, the processor 51 proceeds to ACT 53. In ACT 53, the processor 51 displays a menu screen based on the menu data, on the touch panel 55.

After checking the menu screen, the user selects a food and drink menu item to be ordered and inputs the number of items ordered. After selecting the food and drink menu item, the user enters an order button arranged in the menu screen.

The processor 51 of the mobile terminal 5 displaying the menu screen waits until the order button is entered in ACT 54. If the order button is entered, the processor 51 proceeds to ACT 55. In ACT 55, the processor 51 controls the wireless communication unit 53 to transmit an order event Ed to the infrastructure server 3. This control causes the order event Ed to be wirelessly transmitted from the mobile terminal 5. The order event Ed is received by the mobile server 2 and transmitted to the infrastructure server 3 via the inter-server network 4. The order event Ed includes order data, that is, the merchandise code of the food and drink menu item selected from the menu screen, and the number of items ordered. The order event Ed also includes the member ID registered in the store app 521 and the store code acquired from the machine-readable code on the reception slip.

After receiving the order event Ed, the processor 31 of the infrastructure server 3 in ACT 113 acquires the store code from the order event Ed. In ACT 114, the processor 31 acquires the member ID from the order event Ed. In ACT 115, the processor 31 searches the linkage table 333 of the store specified by the store code and checks whether the member ID is linked with the room number or not.

If the member ID is not linked with the room number, the processor 31 proceeds to ACT 116. In ACT 116, the processor 31 transmits an order unavailability response event En to the mobile terminal 5 that sent the order event Ed.

On the other hand, if the member ID is linked with the room number, the processor 31 proceeds to ACT 117. In ACT 117, the processor 31 decides the karaoke store specified by the store code as the destination of the order event Ed. In ACT 118, the processor 31 transmits the order event Ed to the store server 11 of the karaoke store decided as the destination. In ACT 119, the processor 31 transmits an order completion response event Eo to the mobile terminal 5 that sent the order event Ed.

In this way, after receiving the order event Ed from a mobile terminal 5, the processor 31 of the infrastructure server 3 transmits the order unavailability response event En to the mobile terminal 5 if the member ID included in the order event Ed is not linked with a room number. On the other hand, if the member ID included in the order event Ed is linked with a room number, the processor 31 transmits the order completion response event Eo to the mobile terminal 5. Thus, by the processing of ACTS 113 to 119, the processor 31 implements the functions of the order permitting unit 316.

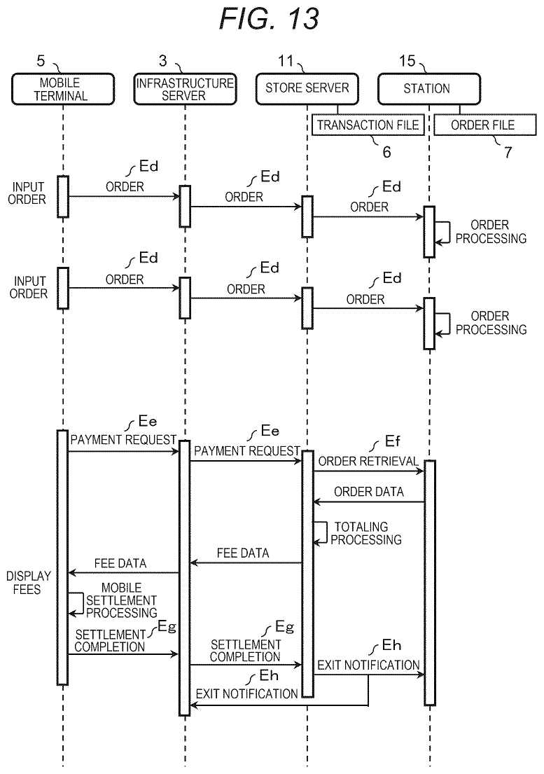

FIG. 13 is a sequence chart for explaining an outline of operations of the facility management system 100 including the mobile terminal 5. In FIG. 13, the same parts as in FIG. 2 are denoted by the same reference signs. As shown in FIG. 13, after receiving the order event Ed from the infrastructure server 3, the store server 11 in the store system 1 transfers the order event Ed to the station 15 in the same store system 1. The station 15 executes order processing every time the station 15 receives the order event Ed. The station 15 adds the order data to the order record 71 in which the room number included in the order event Ed is set.

In this way, the store system 1 including the store server 11 and the station 15 processes the order data sent from the mobile terminal 5, similarly to the order data input via the reception terminal 12.

After transmitting the order event Ed, the processor 51 of the mobile terminal 5 waits for an event from the infrastructure server 3 in ACT 56. If the processor 51 receives the order completion response event Eo from the infrastructure server 3 via the wireless communication unit 53, the processor 51 proceeds to ACT 57. In ACT 57, the processor 51 displays an image showing that the order of the food and drink menu item is complete, on the touch panel 55. On the other hand, if the processor 51 receives the order unavailability response event En from the infrastructure server 3, the processor 51 proceeds to ACT 58. In ACT 58, the processor 51 displays an image showing that the order of the food and drink menu item is unavailable, on the touch panel 55.

In this way, the user of the karaoke box can order a food and drink menu item using the mobile terminal 5 when the mobile terminal 5 is linked to the karaoke box (room number). If the mobile terminal 5 is not linked to a karaoke box, the user can still view the menu image of food and drink menu items using this mobile terminal 5.

### Payment Processing

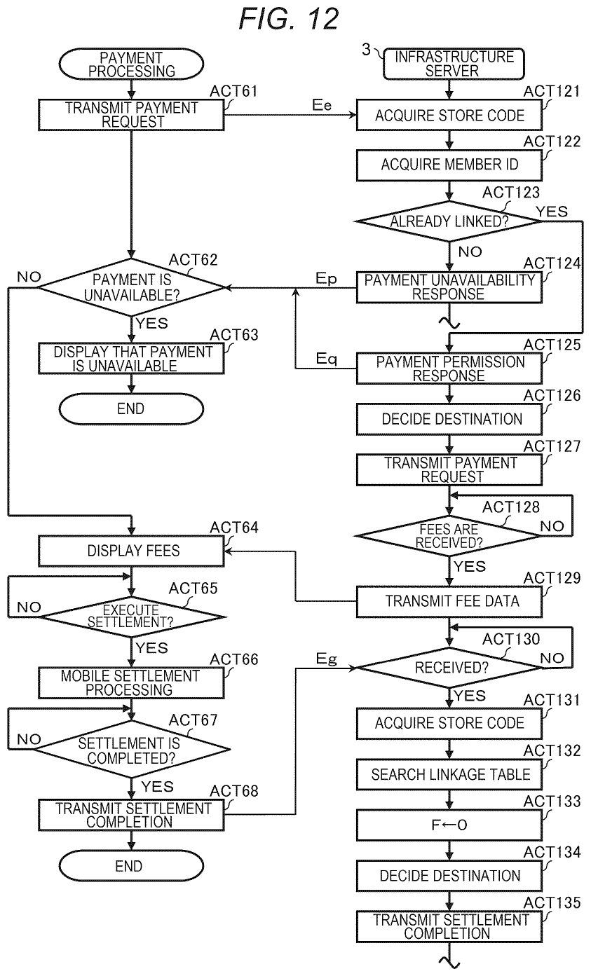

FIG. 12 is a flowchart showing procedures of the payment processing executed by the processor 51 of the mobile terminal 5 and procedures of the information processing executed by the processor 31 of the infrastructure server 3 in conjunction with the payment processing.

As the processor 51 of the mobile terminal 5 starts the payment processing, the processor 51 in ACT 61 controls the wireless communication unit 53 to transmit a payment request event Ee to the infrastructure server 3. This control causes the payment request event Ee to be wirelessly transmitted from the mobile terminal 5. The payment request event Ee is received by the mobile server 2 and transmitted to the infrastructure server 3 via the inter-server network 4. The payment request event Ee includes the member ID registered in the store app 521 and the store code acquired from the machine-readable code on the reception slip.

After receiving the payment request event Ee, the processor 31 of the infrastructure server 3 in ACT 121 acquires the store code from the payment request event Ee. In ACT 122, the processor 31 acquires the member ID from the payment request event Ee. In ACT 123, the processor 31 searches the linkage table 333 of the store specified by the store code and checks whether the member ID is linked with the room number or not.

If the member ID is not linked with a room number, the processor 31 proceeds to ACT 124. In ACT 124, the processor 31 transmits a payment unavailability response event Ep to the mobile terminal 5 that sent the payment request event Ee.

On the other hand, if the member ID is linked with a room number, the processor 31 proceeds to ACT 125. In ACT 125, the processor 31 transmits a payment permission response event Eq to the mobile terminal 5 that is the source of the payment request event Ee. In ACT 126, the processor 31 selects the karaoke store specified by the store code as the destination of the payment request event Ee. In ACT 127, the processor 31 transmits the payment request event Ee to the store server 11 of the destination karaoke store.

As shown in FIG. 13, after receiving the payment request event Ee, the store server 11 transmits an order retrieval event Ef to the station 15. The order retrieval event Ef includes the slip number acquired from the payment request event Ee.

After receiving the order retrieval event Ef, the station 15 acquires the order record 71 including the slip number acquired from the order retrieval event Ef. The station 15 then sends back the order data included in the order record 71 to the store server 11.

The store server 11 executes totaling processing. This processing is adding up the use fee in the transaction record 61 including the slip number acquired from the payment request event Ee and the price of the food and drink menu item calculated based on the order data acquired from the station 15. If the time of exit when the check-out is carried out is later than the scheduled time of exit, the store server 11 adds an extension fee to the use fee. The store server 11 then adds up the use fee (with the extension fee added as applicable) and the price of the food and drink menu item(s).

After finishing the totaling processing, the store server 11 transmits fee data to the payment terminal 13. The fee data is data indicating the amount acquired by adding up the use fee of the karaoke box and the price of the food and drink menu item(s), that is, the fees involved in using or associated with using the karaoke box. The fee data can include details of the fees as separate line items or the like, for example, the use fee of the karaoke box, the item name and the price of each food and drink menu item ordered, the number of items ordered, and the like.

Referring back to FIG. 12, the description continues.

After transmitting the payment request event Ee, the processor 31 of the infrastructure server 3 waits until the fee data is sent thereto from the store server 11 in ACT 128. After the processor 31 receives the fee data, the processor 31 proceeds to ACT 129. In ACT 129, the processor 31 transmits the fee data to the mobile terminal 5 that sent the payment request event Ee.

After receiving the fee data, the processor 51 of the mobile terminal 5 in ACT 64 displays the fees involved in using the karaoke box on the touch panel 55. In ACT 65, the processor 51 waits until mobile settlement is executed. When the user activates the settlement app 522 and gives an instruction to execute mobile settlement, the processor 51 proceeds to ACT 66. In ACT 66, the processor 51 executes a mobile settlement for using the karaoke box. If, for example, credit card settlement is selected as the method for mobile settlement, cashless settlement is executed with data of a credit card registered in the mobile terminal 5. If, for example, electronic money settlement is selected as the method for mobile settlement, cashless settlement is executed with data of electronic money registered in the mobile terminal 5.

In ACT 67, the processor 51 waits until the mobile settlement is completed. If the mobile settlement is completed, the processor 51 proceeds to ACT 68. In ACT 68, the processor 51 controls the wireless communication unit 53 to transmit a settlement completion event Eg to the infrastructure server 3. This control causes the settlement completion event Eg to be wirelessly transmitted from the mobile terminal 5. The settlement completion event Eg is received by the mobile server 2 and transmitted to the infrastructure server 3 via the inter-server network 4. The settlement completion event Eg includes the member ID registered in the store app 521, and the store code and the slip number acquired from the machine-readable code on the reception slip.

After transmitting the fee data to the mobile server 2, the processor 31 of the infrastructure server 3 waits to receive the settlement completion event Eg in ACT 130. After the processor 31 receives the settlement completion event Eg from the mobile server 2, the processor 31 proceeds to ACT 131. In ACT 131, the processor 31 acquires the store code from the settlement completion event Eg. In ACT 132, the processor 31 searches the linkage table 333 specified by the store code. In ACT 133, the processor 31 rewrites the linkage flag F in the column Cd in the linkage table 333 where the store code and the slip number included in the settlement completion event Eg are listed in the columns Cb and Cc, respectively, from “1” to “0”.

In ACT 134, the processor 31 decides the karaoke store specified by the store code acquired from the settlement completion event Eg as the destination of the settlement completion event Eg. In ACT 135, the processor 31 transmits the settlement completion event Eg to the store server 11 of the karaoke store decided as the destination.

As shown in FIG. 13, after receiving the settlement completion event Eg, the store server 11 updates the status of the transaction record 61 in which the slip number acquired from the settlement completion event Eg is set, from the in-use state to the not-in-use state. The store server 11 also transmits an exit notification event Eh to the station 15 and the infrastructure server 3. The exit notification event Eh includes the slip number acquired from the settlement completion event Eg, and the room number in the transaction record 61 in which this slip number is set. The exit notification event Eh also includes the store code. After receiving the exit notification event Eh, the station 15 updates the status of the order record 71 including the room number and the slip number acquired from the exit notification event Eh, from the in-use state to the not-in-use state.

Upon receiving the exit notification event Eh, the infrastructure server 3 executes the processing of ACTS 12 to 15 in FIG. 8.

In this way, after receiving the payment request event terminal Ee from the mobile 5, the processor 31 of the infrastructure server 3 transmits the payment unavailability response event Ep to the mobile terminal 5 if the member ID included in the payment request event Ee is not linked with a room number. On the other hand, if the member ID included in the payment request event Ee is linked with a room number, the processor 31 transmits the payment permission response event Eq to the mobile terminal 5. Thus, by the processing of ACTS 121 to 125, the processor 31 implements the functions of the payment permitting unit 315.

Also, after transmitting the payment permission response event Eq to the mobile terminal 5, the processor 31 transmits the payment request event Ee to the store server 11 of the karaoke store specified by the store code included in the payment request event Ee. After the processor 31 receives the fee data representing the fees calculated by the store server 11 in response to the payment request event Ee, the processor 31 transmits this fee data to the mobile terminal 5. Thus, by the processing of ACTS 126 to 129, the processor 31 implements the functions of the providing unit 312.

Also, after transmitting the fee data to the mobile terminal 5, the processor 31 waits to receive the settlement completion event Eg from the mobile terminal 5. Thus, by the processing of ACT 130, the processor 31 implements the functions of the receiving unit 313.

After receiving the settlement completion event Eg, the processor 31 executes the processing of ACTS 131 to 135. That is, the processor 31 rewrites the linkage flag F corresponding to the room number for which the slip number and the member ID included in the settlement completion event Eg are listed, from “1” to “0” in the linkage table 333. The processor 31 also transmits the settlement completion event Eg to the store server 11 included in the settlement completion event Eg. Thus, by the processing of ACTS 131 to 135, the processor 31 implements the functions of the processing unit 314.

### Effects of Facility Management System

The facility management system 100 according to an embodiment enables mobile settlement of the fees involved in using the karaoke box. The mobile settlement can be performed with the mobile terminal 5 owned by the user of the karaoke box.

Also, even when mobile settlement is carried out using a mobile terminal 5, the status of the transaction record 61 and the order record 71 will be changed from the in-use state to the not-in-use state, just as in the case when settlement is carried out using the payment terminal 13. Therefore, a situation in which the karaoke box that was being used by a user who paid using mobile settlement is still listed in the in-use state even though the settlement was already carried out. Similarly, a situation where the order record of an already settled user is left in the in-use state does not occur. The not-in-use state can also include or be a waiting-for-cleaning state, a cleaning-in-progress state, an available-for-use state, or the like.

### Other Embodiments

In an embodiment, the processor 31 of the infrastructure server 3 provides the functions of the linking unit 311, the providing unit 312, the receiving unit 313, the processing unit 314, the payment permitting unit 315, and the order permitting unit 316. In another embodiment, the processor of the store server 11 may provide the functions of these units or some of these units. That is, the store server 11 may be employed as one form of a facility management device. Such other embodiment may be effective as a facility management device that manages just one facility.

Also, if the mobile server 2 has a data table equivalent to the linkage table 333, the processor of the mobile server 2 can provide the functions of the payment permitting unit 315 and the order permitting unit 316. In this case, the infrastructure server 3 and the mobile server 2 together form a facility management device.

In an embodiment, a karaoke box is employed as the example facility. The facility is not limited to a karaoke box. For example, an embodiment can be applied to facilities such as a darts bar and a manga café, and mobile settlement with a mobile terminal 5 becomes available in such other types of facilities as well.

In an embodiment, the member ID is used as an example of the terminal information that identifies the mobile terminal 5 being used by a particular user. The terminal information that can be used is not limited to the member ID. For example, if the mobile terminal 5 is a smartphone, the telephone number may be used as the terminal information. The facility information is not limited to a room number. For example, any information that can specify a particular portion, location, region, division, or the like of a facility, such as the room name or the seat number, can be used as the facility information.

While some embodiments of the present disclosure have been described, these embodiments are presented simply as examples and are not intended to limit the scope of the present disclosure. These novel embodiments can be implemented in various other forms and can include various omissions, replacements, and changes without departing from the spirit and scope of the present disclosure. These embodiments and modifications thereof are included in the spirit and scope of the present disclosure and also included in the scope of the claims and equivalents thereof.

What is claimed is:

1. A facility management device, comprising:
a storage device;
a communication interface configured to connect a store server; and
a processor configured to:
in a linkage table in the storage device, link facility information that specifies a facility being used by a user to terminal information that specifies a mobile terminal used by the user;
receive fee data indicating fees associated with use of the facility by the user via the communication interface from the store server;
provide the fee data to the mobile terminal linked to the facility information of the facility in the linkage table;
receive a payment notification indicating that a payment of the fees has been executed at the mobile terminal; and
execute processing for changing a use status of the facility after the payment notification is received.

2. The facility management device according to claim 1, wherein the terminal information is input at a reception terminal that accepts a start of use of the facility.

3. The facility management device according to claim 1, wherein the terminal information is provided by the mobile terminal reading a slip dispensed from a reception terminal that accepts a start of use of the facility.

4. The facility management device according to claim 1, wherein the processor is further configured to:
receive a payment request via the communication interface, then check whether terminal information included with the payment request is linked to facility information in the linkage table, and permit a payment process only if the terminal information is linked to facility information.

5. The facility management device according to claim 1, wherein the processor is further configured to:
receive a merchandise order request from the mobile terminal via the communication interface, then check whether terminal information included with the merchandise order request is linked to facility information in the linkage table, and accept a merchandise order only if the terminal information is linked to facility information.

6. The facility management device according to claim 5, wherein the fees associated with use of the facility includes merchandise orders of the user entered while using the facility.

7. The facility management device according to claim 1, wherein the fees associated with use of the facility includes merchandise orders of the user entered while using the facility.

8. The facility management device according to claim 7, wherein the communication interface is connected to a plurality of store servers and a mobile server that is configured to connect to mobile terminals of users.

9. The facility management device according to claim 1, wherein the communication interface is connected to a plurality of store servers and a mobile server that is configured to connect to mobile terminals of users.

10. A facility management system, comprising:
a plurality of store servers at plurality of facility locations, each store server locally connected to a reception terminal, a payment terminal, a kitchen terminal, and a station terminal; and
an infrastructure terminal including:
a storage device;
a communication interface configured to connect the store server; and
a processor configured to:
in a linkage table in the storage device, link facility information that specifies a facility being used by a user to terminal information that specifies a mobile terminal used by the user;
receive fee data indicating fees associated with use of the facility by the user via the communication interface from the store server;
provide the fee data to the mobile terminal linked to the facility information of the facility in the linkage table;
receive a payment notification indicating that a payment of the fees has been executed at the mobile terminal; and
execute processing for changing a use status of the facility after the payment notification is received.

11. The facility management system according to claim 10, wherein the terminal information is input at the reception terminal that accepts a start of use of the facility.

12. The facility management system according to claim 10, wherein the terminal information is provided by the mobile terminal reading a slip dispensed from a reception terminal that accepts a start of use of the facility.

13. The facility management system according to claim 10, wherein the processor is further configured to:
receive a payment request via the communication interface, then check whether terminal information included with the payment request is linked to facility information in the linkage table, and permit a payment process only if the terminal information is linked to facility information.

14. The facility management system according to claim 10, wherein the processor is further configured to:
receive a merchandise order request from the mobile terminal via the communication interface, then check whether terminal information included with the merchandise order request is linked to facility information in the linkage table, and accept a merchandise order only if the terminal information is linked to facility information.

15. A facility management method, comprising:
in a linkage table in a storage device, linking facility information that specifies a facility being used by a user to terminal information that specifies a mobile terminal used by the user;
receiving fee data indicating fees associated with use of the facility by the user via a communication interface from the store server;
providing the fee data to the mobile terminal linked to the facility information of the facility in the linkage table;
receiving a payment notification indicating that a payment of the fees has been executed at the mobile terminal; and
executing processing for changing a use status of the facility after the payment notification is received.

16. The facility management method according to claim 15, wherein the terminal information is input at a reception terminal that accepts a start of use of the facility.

17. The facility management method according to claim 15, wherein the terminal information is provided by the mobile terminal reading a slip dispensed from a reception terminal that accepts a start of use of the facility.

18. The facility management method according to claim 15, further comprising:
receiving a payment request via the communication interface, then checking whether terminal information included with the payment request is linked to facility information in the linkage table, and permitting a payment process only if the terminal information is linked to facility information.

19. The facility management method according to claim 15, further comprising:
receiving a merchandise order request from the mobile terminal via the communication interface, then checking whether terminal information included with the merchandise order request is linked to facility information in the linkage table, and accepting a merchandise order only if the terminal information is linked to facility information.

20. The facility management method according to claim 15, wherein the fees associated with use of the facility includes merchandise orders of the user entered while using the facility.
